(19) United States
(12) Patent Application Publication
(10) Pub. No.: US 2021/0308932 A1
(43) Pub. Date: Oct. 7, 2021

(54) WINDING DEVICE AND MANUFACTURING METHOD OF WINDING BODY

(71) Applicant: KABUSHIKI KAISHA TOSHIBA, Tokyo (JP)

(72) Inventor: Toshiyuki KISHI, Yokohama (JP)

(73) Assignee: KABUSHIKI KAISHA TOSHIBA, Tokyo (JP)

(21) Appl. No.: 17/217,171

(22) Filed: Mar. 30, 2021

(30) Foreign Application Priority Data
Apr. 1, 2020 (JP) 2020-065621

(51) Int. Cl. B29C 53/62; B29C 53/80; H01M 50/538

(52) U.S. Cl. CPC B29C 53/62; B29L 2031/3468; H01M 50/538; B29C 53/8016

(57) ABSTRACT

According to the embodiments, a winding device is a device for manufacturing a winding body obtained by winding a plurality of band bodies including a first band body and a second band body. The winding device includes a core and an adjuster. The core winds a plurality of band bodies thereonto by rotating. The adjuster varies the size of an area of a region between a first position and a second position on an outer circumferential surface of the core, in which the first position is a position at which the first band body starts contacting a member on an inner side thereof, and the second position is a position at which the second band body starts contacting the first band body.

### CROSS-REFERENCE TO RELATED APPLICATIONS

This application is based upon and claims the benefit of priority from the prior Japanese Patent Application No. 2020-065621, filed Apr. 1, 2020, the entire contents of which are incorporated herein by reference.

### FIELD

Embodiments described herein relate generally to a winding device and a manufacturing method of a winding body.

### BACKGROUND

As an example of a winding body in which a plurality of band bodies are wound in an overlapped state, there is an electrode group to be used for a secondary battery such as a lithium ion battery. For example, when manufacturing band bodies that form an electrode group to be used for a secondary battery, a band body forming a negative electrode of a battery (a negative electrode sheet) and a band body forming a positive electrode of a battery (a positive electrode sheet) are held on a core in an overlapped state, and the core is rotated. In this manner, the two band bodies are wound on the core. Here, the band body forming the negative electrode of the battery and the band body forming the positive electrode of the battery are individually transferred in a state where tension is applied, and, after being aggregated immediately before arriving at the core, are wound onto the core.

When manufacturing band bodies that form an electrode group of a battery, in some cases, for example, the band bodies are formed in a state where deformation from pressing still remains (in a bent state). Even when winding band bodies are bent in such a manner, it is required that positional deviations of other band bodies onto which the bent band bodies are adhered from the outer side be suppressed, to suppress the occurrence of the winding deviation.

### BRIEF DESCRIPTION OF THE DRAWINGS

FIG. 1 is a schematic diagram showing an example of a winding device according to a first embodiment.

FIG. 2 is a block diagram showing an example of a control configuration of the winding device according to the first embodiment.

FIG. 3 is a schematic diagram showing one of a plurality of band bodies attached to a core of the winding device according to the first embodiment.

FIG. 4 is a schematic diagram showing an aspect of another band body being supplied to the core, the another band body being different from the band body attached to the core of the winding device according to the first embodiment.

FIG. 5 is a schematic diagram showing a state in which a plurality of band bodies are attached to the core of the winding device according to the first embodiment.

FIG. 6 is a schematic diagram showing an aspect of moving rollers in a state where a plurality of band bodies are attached to the core of the winding device according to the first embodiment.

FIG. 7 is a schematic diagram showing an aspect of winding a plurality of band bodies onto the core of the winding device according to the first embodiment.

FIG. 8 is a schematic diagram showing an aspect of moving rollers in a state where a plurality of band bodies are attached to a core of a winding device according to a modification of the first embodiment.

FIG. 9 is a schematic diagram showing a state in which two of a plurality of band bodies are attached to a core of a winding device according to a second embodiment.

FIG. 10 is a schematic diagram showing an aspect of supplying other band bodies to the core, the band bodies being different from the two band bodies attached to the core of the winding device according to the second embodiment.

FIG. 11 is a schematic diagram showing an aspect of moving rollers in a state where a plurality of band bodies are attached to the core of the winding device according to the second embodiment.

### DETAILED DESCRIPTION

According to the embodiments, a winding device is a device for manufacturing a winding body obtained by winding a plurality of band bodies including a first band body and a second band body that adheres to the first band body from the outer side, in a state where the band bodies overlap. The winding device includes a core and an adjuster. The core has a center axis, and winds a plurality of band bodies thereonto by rotating around the center axis. The adjuster varies the size of an area of a region between a first position and a second position on an outer circumferential surface of the core, in which the first position is a position at which the first band body starts contacting a member on an inner side thereof from the outer side, and the second position is a position at which the second band body starts contacting the first band body from the outer side.

Hereinafter, embodiments will be described with reference to the drawings.

### First Embodiment

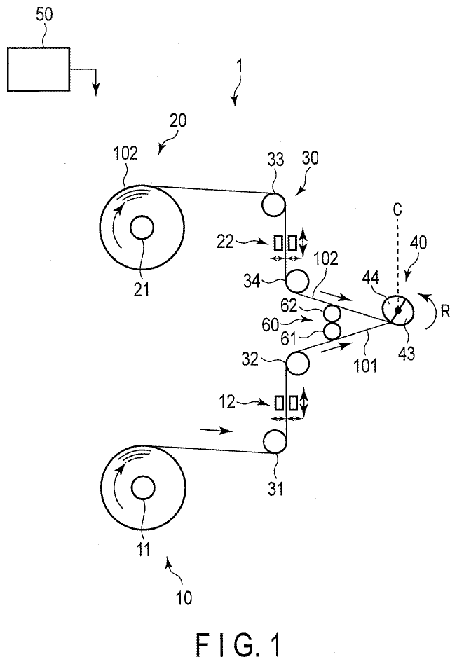

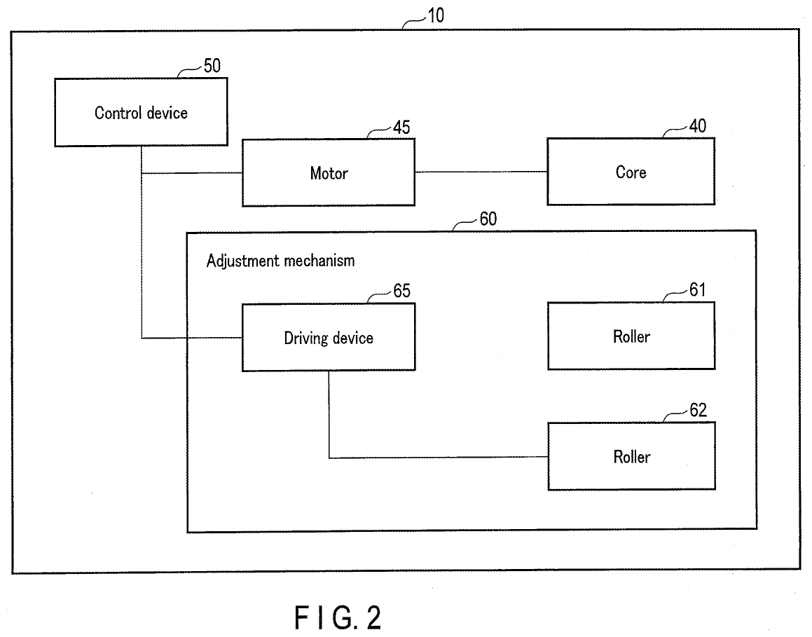

FIG. 1 is a diagram showing a configuration of a winding device 1 according to a first embodiment. FIG. 2 is a block diagram showing a control configuration of the winding device 1 according to the first embodiment. The winding device 1 is a device for manufacturing a winding body obtained by winding a plurality of band bodies in an overlapped state. The winding body is, for example, an electrode group to be used for a secondary battery such as a lithium ion battery. The winding device 1 of the present embodiment is a device for manufacturing an electrode group of a secondary battery using a positive electrode sheet 101 and a negative electrode sheet 102. The positive electrode sheet 101 is an electrode sheet that forms a positive electrode of the secondary battery. The negative electrode sheet 102 is an electrode sheet that forms a negative electrode of the secondary battery. The negative electrode sheet 102 is an example of a first band body, and the positive electrode sheet 101 is an example of a second band body. The winding device 1 manufactures the electrode group of the secondary battery by holding the overlapped positive electrode sheet 101 and negative electrode sheet 102 on a core 40, then rotating the core 40 to wind up the positive electrode sheet 101 and the negative electrode sheet 102. Here, the negative electrode sheet 102 adheres to the outer side of the positive electrode sheet 101.

As shown in FIG. 1, the winding device 1 includes a supplying unit (supplier) 10, a supplying unit (supplier) 20, a transfer unit (transfer) 30, the core 40, a control device (controller) 50, and an adjustment mechanism (adjuster) 60.

The supplying unit 10 includes a holder 11 and a sending device (sender) 12. The holder 11 holds a rolled raw fabric, which is obtained by winding the positive electrode sheet 101, and rotates with respect to a frame (not shown), etc. The sending device 12 is provided in a transfer path between the holder 11 and the core 40. The sending device 12 intermittently feeds the positive electrode sheet 101 by a predetermined length. For example, the sending device 12 grasps the positive electrode sheet 101 and moves to the core 40 side. After releasing the grasped positive electrode sheet 101, the sending device 12 moves to the holder 11 side. The sending device 12 is, for example, a pitch sending mechanism. The sending device 12 may also be a roller, etc. that sandwiches the positive electrode sheet 101 and intermittently feeds the positive electrode sheet 101 by a predetermined length.

The supplying unit 20 includes a holder 21 and a sending device 22. The holder 21 holds a rolled raw fabric, which is obtained by winding the negative electrode sheet 102, and rotates with respect to a frame (not shown), etc. The sending device 22 is provided in a transfer path between the holder 21 and the core 40. The sending device 22 intermittently feeds the negative electrode sheet 102 by a predetermined length. For example, the sending device 22 grasps the negative electrode sheet 102 and moves to the core 40 side. After releasing the negative electrode sheet 102, the sending device 22 moves to the holder 21 side. The sending device 22 is, for example, a pitch sending mechanism. The sending device 22 may also be a roller, etc. that sandwiches the negative electrode sheet 102 and intermittently feeds the negative electrode sheet 102 by a predetermined length.

The positive electrode sheet 101 has a band-like positive electrode current collector and a positive electrode active material-containing layer formed on at least one surface of the positive electrode current collector. The positive electrode current collector is formed of, for example, aluminum foil or aluminum alloy foil. The positive electrode active material-containing layer may contain a positive electrode active material.

The negative electrode sheet 102 has a band-like negative electrode current collector and a negative electrode active material-containing layer formed on at least one surface of the negative electrode current collector. The negative electrode current collector is formed of, for example, aluminum foil or aluminum alloy foil. The negative electrode active material-containing layer may contain a negative electrode active material.

Furthermore, in the present embodiment, an insulating layer is formed integrally with one of the positive electrode sheet 101 or the negative electrode sheet 102. Therefore, in an electrode group manufactured by winding the positive electrode sheet 101 and the negative electrode sheet 102, the insulating layer serves as a separator that electrically insulates the positive electrode from the negative electrode. It should be noted that, instead of the insulating layer, a solid electrolyte-containing layer may also be formed integrally with one of the positive electrode sheet 101 or the negative electrode sheet 102. In this case, in the manufactured electrode group, the solid electrolyte-containing layer electrically insulates the positive electrode from the negative electrode.

The transfer unit 30 is provided between the holder 11 and the core 40, and the holder 21 and the core 40. The transfer unit 30 includes four guide rollers 31 to 34. The guide rollers 31 to 34 are attached to, for example, a frame (not shown).

The guide rollers 31 and 32 are arranged between the holder 11 and the core 40, and guide the positive electrode sheet 101 supplied from the supplying unit 10 to the core 40. The guide rollers 33 and 34 are arranged between the holder 21 and the core 40, and guide the negative electrode sheet 102 supplied from the supplying unit 20 to the core 40.

The transfer path of the negative electrode sheet 102 is positioned so that, with respect to the transfer path of the positive electrode sheet 101, it is on a side opposite to a side at which the core 40 rotates in a circumferential direction around the center axis C of the core 40.

It should be noted that the number and the arrangement of the guide rollers that the transfer unit 30 includes are not limited to what is exemplified, and therefore can be changed as appropriate depending on the arrangement of the holder 11, the holder 21, and the core 40. Furthermore, a dancer roller to control the tension of the positive electrode sheet 101, a dancer roller to control the tension of the negative electrode sheet 102, and the like may be provided for the transfer unit 30.

The core 40 is attached to a frame, etc. (not shown). As shown in FIG. 2, a motor 45 is connected to the core 40. The motor 45 is, for example, a servo motor. The core 40 has a center axis C. By driving the motor 45, the core 40 rotates around the center axis C with respect to a frame, etc.

By grasping the overlapped positive electrode sheet 101 and negative electrode sheet 102, and rotating them around the center axis C, the core 40 winds the positive electrode sheet 101 and the negative electrode sheet 102 onto the outer circumferential surface. The cross-sectional shape of the core 40 on a cross section perpendicular to or approximately perpendicular to the center axis C may be changed as appropriate depending on the form of the winding body to be manufactured.

The core 40 is formed in an approximately columnar shape. The cross-sectional shape of the core 40 on a cross section perpendicular to or approximately perpendicular to the center axis C is approximately circular. Therefore, by winding the positive electrode sheet 101 and the negative electrode sheet 102 onto the outer circumference of the core 40, an approximately cylindrical electrode group can be manufactured. The cross-sectional shape of the core 40 on a cross section perpendicular to or approximately perpendicular to the center axis C may be an oval, a polygon, or the like.

The core 40 includes a grasping body 43 and a grasping body 44. Each of the grasping body 43 and the grasping body 44 is formed approximately semicircularly on the cross-section of the core 40 which is perpendicular to or approximately perpendicular to the center axis C. The positive electrode sheet 101 is inserted between the grasping body 43 and the grasping body 44 to be grasped therebetween. In this manner, the positive electrode sheet 101 is attached to the core 40.

As shown in FIG. 2, the adjustment mechanism 60 includes a roller 61, a roller 62, and a driving device (driver) 65. As shown in FIG. 1, the roller 61 and the roller 62 are positioned so that, with respect to the transfer path of the positive electrode sheet 101, they are on a side opposite to a side at which the core 40 rotates in the circumferential direction around the center axis C of the core 40, and, with respect to the transfer path of the negative electrode sheet 102, they are on the same side as a side at which the core 40 rotates. That is, the roller 61 and the roller 62 are arranged between the positive electrode sheet 101 and the negative electrode sheet 102 supported between the transfer unit 30 and the core 40. Each of the roller 61 and the roller 62 is attached to, for example, a frame (not shown). Each of the roller 61 and the roller 62 may have only one end in an axial direction (longitudinal direction) or both ends in the axial direction fixed to the frame, etc. The roller 62 is an example of a first roller, and the roller 61 is an example of a second roller.

The roller 61 is arranged between the guide roller 32, which is the closest to the core 40 among the guide rollers provided in the transfer path of the positive electrode sheet 101, and the core 40. The roller 61 guides the positive electrode sheet 101 supplied from the supplying unit 10 via the guide roller 32 to the core 40. Depending on the position of the roller 61, the insertion angle of the positive electrode sheet 101 changes with respect to the core 40. That is, the roller 61 defines the insertion angle of the positive electrode sheet 101 with respect to the core 40.

The roller 62 is arranged between the guide roller 34, which is the closest to the core 40 among the guide rollers provided in the transfer path of negative electrode sheet 102, and the core 40. The driving device 65 is connected to the roller 62. The driving device 65 is driven to move the roller 62. Specifically, the driving device 65 is driven to move the roller 62 between a reference position and a winding position. By driving the driving device 65, the roller 62 is able to move in the circumferential direction around the center axis C of the core 40.

In a certain embodiment, the driving device 65 includes a slider and a servo motor, wherein the slider and the servo motor are driven to move the roller 62 along a predetermined direction. In another embodiment, the driving device 65 includes an arm and an air cylinder, wherein one end of the arm is rotatably attached to a frame, etc., and the other end of the arm is fixed to the roller 62. Furthermore, the air cylinder is connected to the arm. The air cylinder rotates the arm by expanding/contracting along a predetermined direction. By rotating the arm, the roller 62 moves along an arc around a rotation axis of the arm.

The reference position is a position at which the rollers are set when attaching the positive electrode sheet 101 and the negative electrode sheet 102 to the core 40. When attaching the positive electrode sheet 101 and the negative electrode sheet 102 to the core 40, in a state where an end part of the positive electrode sheet 101 is grasped by the core 40, the negative electrode sheet 102 is inserted between the outer circumferential surface of the core 40 and the positive electrode sheet 101. In a state where the roller 62 is positioned at the reference position, the insertion angle of the negative electrode sheet 102 with respect to the core 40 is in a state of being close to the insertion angle of the positive electrode sheet 101 with respect to the core 40, which makes it easy for an end part of the negative electrode sheet 102 to be inserted between the core 40 and the positive electrode sheet 101.

The winding position is a position at which the rollers are set when winding the positive electrode sheet 101 and the negative electrode sheet 102 onto the core 40. The winding position of the roller 62 is positioned so that, with respect to the reference position, it is positioned on a side opposite to a side at which the core 40 rotates in a circumferential direction around the center axis C of the core 40. Furthermore, the winding position of the roller 62 is positioned so that, with respect to the reference position, it is positioned on a side away from the roller 61 in a circumferential direction around the center axis C of the core 40.

By moving from the reference position to the winding position, the roller 62 moves to an opposite side of a side at which the core 40 rotates in the circumferential direction around the center axis C of the core 40. Furthermore, by moving from the winding position to the reference position, the roller 62 moves to the same side as a side at which the core 40 rotates in the circumferential direction around the center axis C of the core 40. Depending on the position of the roller 62, the insertion angle of the negative electrode sheet 102 with respect to the core 40 changes. For example, by moving the roller 62 between the reference position and the winding position, the insertion angle of the negative electrode sheet 102 supplied from the supplying unit 20 with respect to the core 40 changes. The roller 62 defines the insertion angle of the negative electrode sheet 102 with respect to the core 40.

The control device (controller) 50 is, for example, a computer. The control device 50 includes a processor or an integrated circuit (control circuit) including a central processing unit (CPU), an application specific integrated circuit (ASIC), or a field programmable gate array (FPGA), and a storage medium, such as a memory. The control device 50 may include only one integrated circuit, etc., or a plurality of integrated circuits, etc. The control device 50 performs processing by executing a program, etc. stored on the storage medium, etc. The control device 50 controls operations of each element provided in the winding device 1. The control device 50 controls, for example, driving of the motor 45 and the driving device 65 of the adjustment mechanism 60. The control device 50 may further include an input unit for an operator to input a process condition or an operation condition, etc., or a display unit for displaying an operation status or abnormality, etc.

Furthermore, the control device 50 moves the roller 62 from the reference position to the winding position based on the positive electrode sheet 101 and the negative electrode sheet 102 being attached to the core 40. Furthermore, the control device 50 starts winding the positive electrode sheet 101 and the negative electrode sheet 102 onto the core 40 based on the roller 62 moving from the reference position to the winding position. Furthermore, the control device 50 moves the roller 62 from winding position to the reference position based on ending of the winding of the positive electrode sheet 101 and the negative electrode sheet 102 onto the core 40. Furthermore, the control device 50 increases a contact area of the negative electrode sheet 102 with respect to an outer circumferential surface of the core 40 when the positive electrode sheet 101 and the negative electrode sheet 102 are wound onto the core 40, compared to when the positive electrode sheet 101 and the negative electrode sheet 102 are attached to the core 40. The control device 50 is an example of a controller.

Operations of the winding device 1 of the present embodiment will now be described.

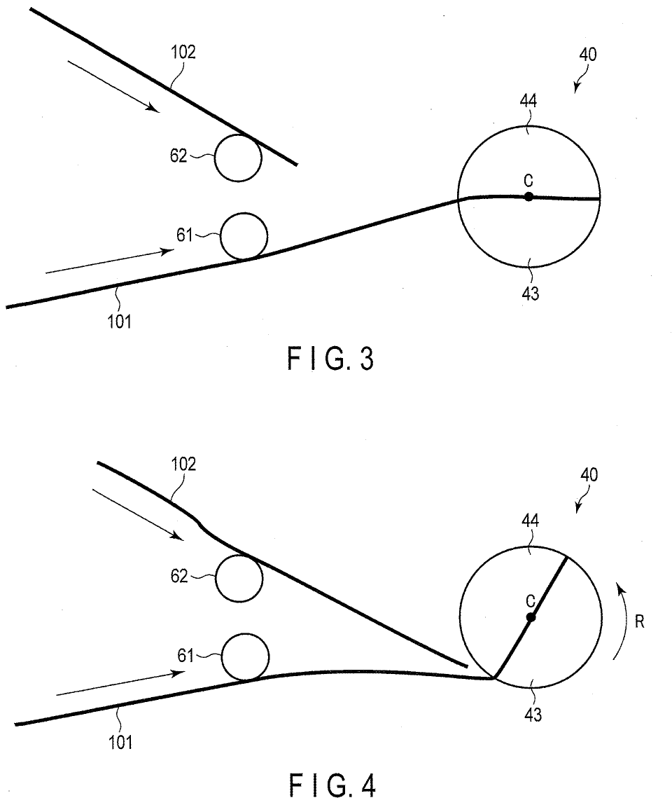

When manufacturing the electrode group which is a winding body of the positive electrode sheet 101 and the negative electrode sheet 102 by using the winding device 1 of the present embodiment, the control device 50 first starts an attachment process. In the attachment process, the control device 50 first inserts the positive electrode sheet 101 between the grasping body 43 and the grasping body 44. The positive electrode sheet 101 is attached to the core 40 by being grasped between the grasping body 43 and the grasping body 44. FIG. 3 shows a state in which the positive electrode sheet 101 is grasped by the core 40.

The control device 50 then rotates the core 40 at a speed slower than the speed of a winding process explained later in a state where the roller 62 is positioned at the reference position, and inserts an end part of the negative electrode sheet 102 between the positive electrode sheet 101 and the outer circumferential surface of the core 40. FIG. 4 shows an aspect of inserting the end part of the negative electrode sheet 102 between the positive electrode sheet 101 and the outer circumferential surface of the core 40. By inserting a certain amount of the end part of the negative electrode sheet 102 between the positive electrode sheet 101 and the outer circumferential surface of the core 40, the negative electrode sheet 102 is attached to the core 40. Here, for example, the control device 50 detects the tension acting on the negative electrode sheet 102 by a sensor, etc., determines that the negative electrode sheet 102 has been attached to the core 40 based on the detected tension reaching a predetermined magnitude or more, and stops the rotation of the core 40. Alternatively, the control device 50 may determine that the negative electrode sheet 102 has been attached to the core 40 based on a rotation angle of the core 40 reaching a predetermined magnitude or more. when the negative electrode sheet 102 is attached to the core 40, the control device 50 ends the attachment process.

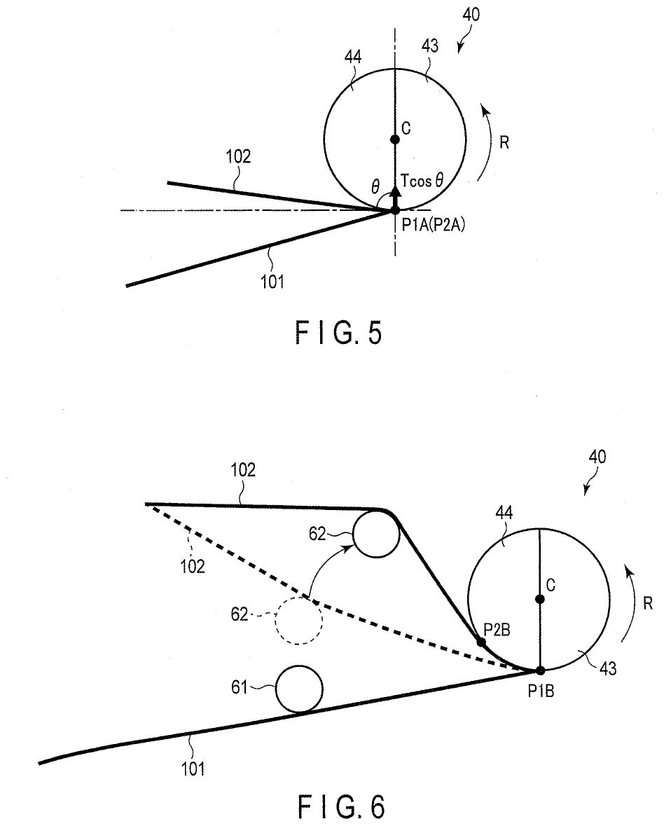

FIG. 5 shows the state of the core 40, the positive electrode sheet 101, and the negative electrode sheet 102 at the time of ending the attachment process. As shown in FIG. 5, at the time of ending the attachment process, the negative electrode sheet 102 is adhered to the outer circumferential surface of the core 40 from the outer side, and the positive electrode sheet 101 is adhered to the outer circumferential surface of the negative electrode sheet 102 from the outer side.

Here, at the time of ending the attachment process, a position at which the positive electrode sheet 101 supplied from the supplying unit 10 starts contacting the outer circumferential surface of the negative electrode sheet 102 will be referred to as a contact starting position P1A. The contact starting position P1A is a point at which the positive electrode sheet 101 starts contacting the negative electrode sheet 102, which is arranged on the inner side in the radial direction of the core 40, from the outer side. That is, the contact starting position P1A is a boundary at which the contact state of the positive electrode sheet 101 with respect to the negative electrode sheet 102 changes. At a portion positioned on a side to which the core 40 rotates beyond the contact starting position P1A in the circumferential direction around the center axis C, the positive electrode sheet 101 is adhered to the negative electrode sheet 102 from the outer side. At a portion positioned on a side opposite to the side to which the core 40 rotates beyond the contact starting position P1A in the circumferential direction around the center axis C, the positive electrode sheet 101 does not contact the negative electrode sheet 102. The contact starting position P1A forms a virtual straight line or an approximately straight line extending along the center axis C of the core 40 on the outer circumferential surface of the core 40.

At the time of ending the attachment process, a position at which the negative electrode sheet 102 supplied from the supplying unit 20 starts contacting a member on the inner side from the outer side will be referred to as a contact starting position P2A. The contact starting position P2A is a position at which the negative electrode sheet 102 starts contacting the outer peripheral surface of the core 40 or the positive electrode sheet 101. Here, the contact starting position P2A will be described as a position at which the negative electrode sheet 102 starts contacting the outer peripheral surface of the core 40.

The contact starting position P2A is a point at which the negative electrode sheet 102 starts contacting the outer circumferential surface of the core 40, which is arranged on the inner side in the radial direction of the core 40, from the outer side. That is, the contact starting position P2A is a boundary at which the contact state of the negative electrode sheet 102 changes with respect to the core 40. At a portion positioned on a side to which the core 40 rotates beyond the contact starting position P2A in the circumferential direction around the center axis C, the negative electrode sheet 102 is adhered to the core 40 from the outer side. At a portion positioned on a side opposite to the side to which the core 40 rotates beyond the contact starting position P2A in the circumferential direction around the center axis C, the negative electrode sheet 102 does not contact the core 40. The contact starting position P2A forms a virtual straight line or an approximately straight line extending along the center axis C of the core 40 on the outer circumferential surface of the core 40.

In a state where the negative electrode sheet 102 is attached to the core 40, the supplying unit 20 causes a tension T to act on the negative electrode sheet 102 via the roller 62. The tension T is a force that pulls the negative electrode sheet 102 in a direction from the contact starting position P2A of the negative electrode sheet 102 toward the roller 62.

Furthermore, a frictional force that acts between the outer circumferential surface of the core 40 and the negative electrode sheet 102 at the contact starting position P1A of the positive electrode sheet 101 is proportional to a force F (=T cos θ) acting on the outer circumferential surface of the core 40 from the negative electrode sheet 102, and a friction coefficient μ between the outer circumferential surface of the core 40 and the negative electrode sheet 102. Here, θ is an acute angle that is formed by a straight line passing through the contact starting position PIA of the positive electrode sheet 101 and the center axis C of the core 40, and a direction in which the tension T acts. The frictional force increases as an area of a region S between the contact starting position P1A of the positive electrode sheet 101 and the contact starting position P2A of the negative electrode sheet 102 on the outer circumferential surface of the core 40 increases. In the region S between the contact starting position P1A and the contact starting position P2A, the negative electrode sheet 102 adheres to the core 40 from the outer side, and the negative electrode sheet 102 is positioned on the outermost side (outermost circumference). Therefore, in the region S between the contact starting position P1A and the contact starting position P2A, the outer circumferential surface of the negative electrode sheet 102 is exposed to the outer side. The frictional force acting between the outer circumferential surface of the core 40 and the negative electrode sheet 102 functions as a resistance force against a winding deviation of the negative electrode sheet 102 with respect to the core 40 at the contact starting position P1A. Therefore, the resistance force against the winding deviation of the negative electrode sheet 102 with respect to the core 40 is proportional to the area of the region S between the contact starting position P1A and the contact starting position P2A.

At the time of ending the attachment process, the contact starting position P1A and the contact starting position P2A are in approximately the same position in the circumferential direction around the center axis C of the core 40. Specifically, the contact starting position P2A is a position that is slightly moved to an opposite side of a side at which the core 40 rotates in the circumferential direction around the center axis C, with respect to the contact starting position P1A. Therefore, the area of the region S between the contact starting position P1A and the contact starting position P2A is approximately zero. Accordingly, the resistance force against the winding deviation of the negative electrode sheet 102 with respect to the core 40 is approximately zero at the time of ending the attachment process.

After ending the attachment process, the control device 50 starts a moving process. In the moving process, the control device 50 controls the driving device 65 to be driven to move the roller 62 from the reference position to the winding position. FIG. 6 shows an aspect of moving the roller 62 from the reference position to the winding position. Here, the roller 62 moves to a side opposite to a rotational direction R of the core 40 in the circumferential direction around the center axis C of the core 40. When the roller 62 moves from the reference position to the winding position, a distance between the roller 62 and the roller 61 in the circumferential direction around the center axis C becomes farther apart than that in a state where the end part of the negative electrode sheet 102 can be guided to the core 40 upon attachment. After the roller 62 has been moved, the control device 50 ends the moving process. The moving process may be executed in a state where the core 40 is rotated at low speed, or may be executed in a state where the rotation of the core 40 is stopped.

After ending the moving process, the control device 50 starts a winding process. In the winding process, in a state where the roller 62 is positioned at the winding position, the control device 50 rotates the core 40 around the center axis C to wind the positive electrode sheet 101 and the negative electrode sheet 102 onto the core 40. In this manner, a winding body is formed by the positive electrode sheet 101 and the negative electrode sheet 102. When the winding body is formed, the control device 50 ends the winding process.

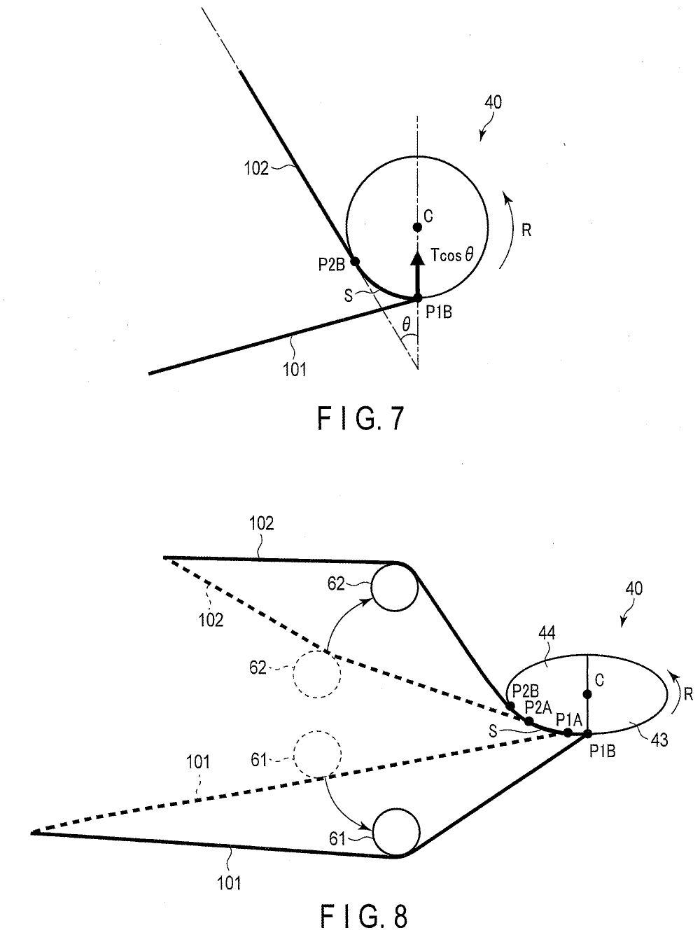

FIG. 7 shows the state of the core 40, the positive electrode sheet 101, and the negative electrode sheet 102 in the winding process. As shown in FIG. 7, in the winding process, as a result of moving the roller 62, the insertion direction of the negative electrode sheet 102 with respect to the core 40 is changed from the attachment process. This causes the direction in which the tension T acts on the negative electrode sheet 102 to change.

Here, in the winding process, a position at which the positive electrode sheet 101 supplied from the supplying unit 10 starts contacting the outer circumferential surface of the negative electrode sheet 102 from the outer side will be referred to as a contact starting position P1B. The contact starting position P1B becomes approximately the same position as the contact starting position P1A at the time of ending the attachment process.

Furthermore, in the winding process, a position at which the negative electrode sheet 102 supplied from the supplying unit 20 starts contacting a member on the inner side will be referred to as a contact starting position P2B. The contact starting position P2B is a position at which the negative electrode sheet 102 starts contacting the outer peripheral surface of the core 40 or the positive electrode sheet 101. Here, the contact starting position P2B will be described as a position at which the negative electrode sheet 102 starts contacting the outer peripheral surface of the core 40.

The contact starting position P2B is a position on the side opposite to a side at which the core 40 rotates in the circumferential direction around the center axis C, with respect to the contact starting position P2A. The angle (angle position) between the contact starting position P2B and the contact starting position P2A in the circumferential direction around the center axis C is, for example, 30 degrees or more. In the winding process, in comparison to the time at which the attachment process is ended, an area of a region S between the contact starting position P1B of the positive electrode sheet 101 and the contact starting position P2B of the negative electrode sheet 102 on the outer circumferential surface of the core 40 becomes larger. Furthermore, in the winding process, in comparison to the time at which the attachment process is ended, an angle θ of an acute angle formed by a straight line passing through the contact starting position P1B and the center axis C, and a direction in which the tension T acts becomes smaller. Therefore, in the winding process, in comparison to the time at which the attachment process is ended, a frictional force acting between the outer circumferential surface of the core 40 and the negative electrode sheet 102 at the contact starting position P1B of the positive electrode sheet 101 becomes larger. By increasing the frictional force, in the winding process, in comparison to the time at which the attachment process is ended, the resistance force becomes larger against the winding deviation of the negative electrode sheet 102 with respect to the core 40.

An effect of the winding device 1 of the present embodiment will now be described.

The positive electrode sheet 101, which is an electrode, is formed, for example, by pressing a base material on which an electrode material is coated using a roll press machine. Here, in some cases, the roll press machine may press the positive electrode sheet 101 to be formed in a state where deformation remains (in a bent state). In the case where the bent positive electrode sheet 101 is used to manufacture a secondary battery, in some cases, a bending moment may occur on the positive electrode sheet 101 by pulling the positive electrode sheet 101 between the core 40 and the supplying unit 10. In the case where the bending moment occurs on the positive electrode sheet 101, when winding the positive electrode sheet 101 and the negative electrode sheet 102 onto the core 40, a counterforce of the bending moment occurring on the positive electrode sheet 101 acts from the positive electrode sheet 101 to the core 40 and the negative electrode sheet 102 positioned on the inner side of the positive electrode sheet 101. In such a case, the counterforce acting from the positive electrode sheet 101 to the negative electrode sheet 102 may cause a winding deviation to occur at a contact starting position at which the positive electrode sheet 101 starts contacting the outer circumferential surface of the negative electrode sheet 102 from the outer side.

The winding device 1 of the present embodiment includes the adjustment mechanism 60. The adjustment mechanism 60 causes an area of a region S between the contact starting position (P2A, P2B) and the contact starting position (P1A, P1B) on the outer circumferential surface of the core 40 to change. The contact starting position (P2A, P2B) is a position at which the negative electrode sheet 102 starts contacting the core 40. The contact starting position (P1A, P1B) is a position at which the positive electrode sheet 101 starts contacting the negative electrode sheet 102 on the inner side of the positive electrode sheet 101 from the outer side. Furthermore, the area of the region S at the time of winding the negative electrode sheet 102 and the positive electrode sheet 101 onto the core 40 is larger than the area of the region S at the time of attaching the negative electrode sheet 102 and the positive electrode sheet 101 to the core 40.

Here, the negative electrode sheet 102 is an example of the first band body, and the positive electrode sheet 101 is an example of the second band body. Furthermore, the contact starting position (P2A, P2B) is an example of the first position, and the contact starting position (P1A, P1B) is an example of the second position.

According to the winding device 1 of the present embodiment, the above configuration allows the area of the region S at the time of winding the positive electrode sheet 101 and the negative electrode sheet 102 to become larger than that at the time of attaching the positive electrode sheet 101 and the negative electrode sheet 102 to the core 40. In region S, the negative electrode sheet 102 is positioned on the outermost side and contacts the outer circumferential surface of the core 40 from the outer side. As the region S increases, a frictional force acting between the outer circumferential surface of the core 40 and the negative electrode sheet 102 at the time of winding the positive electrode sheet 101 and the negative electrode sheet 102 increases. When the frictional force acting between the outer circumferential surface of the core 40 and the negative electrode sheet 102 increases at the time of winding the positive electrode sheet 101 and the negative electrode sheet 102, the resistance force against the winding deviation of the negative electrode sheet 102 with respect to the core 40 increases. Therefore, for example, even in a case where the counterforce of the bending moment occurring on the positive electrode sheet 101 acts on the negative electrode sheet 102 from the positive electrode sheet 101, the winding deviation of the negative electrode sheet 102 with respect to the core 40 can be effectively prevented from occurring at the contact starting position P1B. By preventing the winding deviation of the negative electrode sheet 102 from occurring, the occurrence of defects upon winding can be reduced. Furthermore, by preventing the winding deviation of the negative electrode sheet 102 from occurring, high-speed winding can be made possible, thereby improving productivity of the winding body.

Furthermore, in the present embodiment, the adjustment mechanism 60 includes the roller 62 and the driving device 65 for moving the roller 62. The roller 62 is positioned at the reference position at the time of attaching the negative electrode sheet 102 and the positive electrode sheet 101 to the core 40. At the reference position, when attaching the end part of the negative electrode sheet 102 to the core 40, the roller 62 is capable of guiding the negative electrode sheet 102 to the core 40. At the time of winding the positive electrode sheet 101 and the negative electrode sheet 102, the driving device 65 is driven to move the roller 62 to the winding position. Compared to the reference position, in the winding position, the roller 62 is distanced farther apart from the roller 61 that guides the positive electrode sheet 101 to the core 40 in a circumferential direction around the center axis C of the core 40. Therefore, in a state where the roller 62 is positioned at the winding position, in comparison to a state in which the roller 62 is positioned at the reference position, the area of the region S between the contact starting position (P2A, P2B) and the contact starting position (P1A, P1B) is larger. Furthermore, when the roller 62 moves to the opposite side of the rotational direction R of the core 40, and the contact area between the roller 62 and the negative electrode sheet 102 and the contact area between the guide roller 34 and the negative electrode sheet 102 increases, the frictional forces of the negative electrode sheet 102 will increase with respect to the guide roller 34 and the roller 62. Therefore, in the winding process, in comparison to the time at which the attachment process is ended, the resistance force against the winding deviation of the negative electrode sheet 102 with respect to the core 40 becomes larger, which allows high-speed winding to be performed.

Therefore, according to the winding device 1 of the present embodiment, when attaching the negative electrode sheet 102 and the positive electrode sheet 101 to the core 40, the negative electrode sheet 102 is made easily attachable to the core 40, and, when winding the positive electrode sheet 101 and the negative electrode sheet 102, a difference is created in the insertion angle with respect to the core 40 between the positive electrode sheet 101 and the negative electrode sheet 102, thereby effectively preventing a winding deviation of the negative electrode sheet 102 from occurring with respect to the core 40.

### First Modification of First Embodiment

In the present modification, a driving device 65 further includes a driving mechanism for moving a roller 61 in addition to a driving mechanism for moving a roller 62. Therefore, the driving mechanism 65 is connected to the roller 61 and the roller 62, respectively.

By driving the driving device 65, the roller 61 is able to move in the circumferential direction around the center axis C of a core 40. The driving device 65 is driven to move the roller 61. Specifically, the driving device 65 is driven to move the roller 61 between a reference position and a winding position.

In a state where the roller 61 is positioned at the reference position, when attaching the end part of a positive electrode sheet 101 supplied from a supplying unit 20 to the core 40, the roller 61 is capable of guiding the positive electrode sheet 101 transferred from a guide roller 32 to the core 40.

The winding position of the roller 61 is positioned so that it is on the same side as a side at which the core 40 rotates in a circumferential direction around the center axis C of the core 40 with respect to the reference position of the roller 61. Furthermore, the winding position is positioned so that it is on a side away from the roller 62 in a circumferential direction around the center axis C of the core 40 with respect to the reference position.

By moving from the reference position to the winding position, the roller 61 moves to the same side as a side at which the core 40 rotates in the circumferential direction around the center axis C of the core 40. Furthermore, by moving from the winding position to the reference position, the roller 61 moves to an opposite side of a side at which the core 40 rotates in the circumferential direction around the center axis C of the core 40. Depending on the position of the roller 61, the insertion angle of the positive electrode sheet 101 with respect to the core 40 changes. For example, by moving the roller 61 between the reference position and the winding position, the insertion angle of the positive electrode sheet 101 supplied from the supplying unit 20 changes with respect to the core 40. The roller 61 defines the insertion angle of the positive electrode sheet 101 with respect to the core 40.

A control device 50 moves each of the roller 61 and the roller 62 from the reference position to the winding position based on the positive electrode sheet 101 and the negative electrode sheet 102 being attached to the core 40. Furthermore, the control device 50 starts winding the positive electrode sheet 101 and the negative electrode sheet 102 onto the core 40 based on the roller 61 and the roller 62 moving from the reference position to the winding position. Furthermore, the control device 50 moves each of the roller 61 and the roller 62 from winding position to the reference position based on the winding of the positive electrode sheet 101 and the negative electrode sheet 102 onto the core 40 ending.

In the present modification, the cross-sectional shape of the core 40 on a cross section perpendicular to or approximately perpendicular to the center axis C is approximately oval.

Operations and effects of the winding device 1 of the present modification will now be described.

When manufacturing an electrode group of a secondary battery which is a winding body of the positive electrode sheet 101 and the negative electrode sheet 102 by using the winding device 1 of the present embodiment, the control device 50 first starts an attachment process. Since the attachment process is performed in the same manner as in the first embodiment, descriptions thereof will be omitted.

FIG. 8 is a diagram for explaining operations of the winding device 1 of the present modification. In FIG. 8, the positive electrode sheet 101, the negative electrode sheet 102, and the rollers 61 and 62 at the time of ending the attachment process are shown by dotted lines. As shown in FIG. 8, in the present modification, a contact starting position P2A is a position that is slightly moved to an opposite side of a side at which the core 40 rotates in the circumferential direction around the center axis C, with respect to a contact starting position P1A.

After the attachment process is ended, the control device 50 starts a moving process. In the moving process, the control device 50 controls the driving device 65 to be driven to move the roller 62 from the reference position to the winding position, and to move the roller 61 from the reference position to the winding position as shown in FIG. 8. Here, the roller 62 moves to an opposite side of a side at which the core 40 rotates, and the roller 61 moves to the same side as the side at which the core 40 rotates, in the circumferential direction around the center axis C. When each of the rollers 61 and 62 is moved from the reference position to the winding position, a distance between the roller 62 and the roller 61 becomes farther apart than that in a state where the end parts of the positive electrode sheet 101 and the negative electrode sheet 102 can be guided to the core 40 upon attachment. After completion of moving the rollers 61 and 62, the control device 50 ends the moving process.

After ending the moving process, the control device 50 starts a winding process. In FIG. 8, the positive electrode sheet 101, the negative electrode sheet 102, and the rollers 61 and 62 in the winding process are shown by solid lines. In the same manner as the first embodiment, a contact starting position P2B is positioned on a side opposite to a side at which the core 40 rotates in the circumferential direction around the center axis C, with respect to the contact starting position P2A. In the present modification, a contact starting position P1B is a position on the same side as the side at which the core 40 rotates in the circumferential direction around the center axis C, with respect to the contact starting position P1A. Therefore, in the winding process, an area of a region S between the contact starting position P1B and the contact starting position P2B on the outer circumferential surface of the core 40 becomes larger than that of the first embodiment. Since a frictional force acting between the outer circumferential surface of the core 40 and the negative electrode sheet 102 at the contact starting position P1B of the positive electrode sheet 101 is proportional to an area of a region S between the contact starting position P1B and the contact starting position P2B, in the present modification, a frictional force acting between the outer circumferential surface of the core 40 and the negative electrode sheet 102 at the contact starting position P1B further increases in the winding process. By further increasing the frictional force in the winding process in comparison to the time at which the attachment process is ended, the resistance force against the winding deviation of the negative electrode sheet 102 with respect to the core 40 becomes larger.

As mentioned above, according to the winding device 1 of the present modification, by moving the roller 61 and the roller 62 respectively in a direction away from each other, a resistance force against the winding deviation of the negative electrode sheet 102 with respect to the core 40 can be further increased. Therefore, for example, even in a case where a counterforce of a bending moment occurring on the positive electrode sheet 101 acts on the negative electrode sheet 102 from the positive electrode sheet 101, the winding deviation of the negative electrode sheet 102 with respect to the core 40 can be effectively prevented from occurring at the contact starting position P1B. Furthermore, when the roller 61 moves in the same direction as the rotational direction R of the core 40, since the contact area between the roller 61 and the positive electrode sheet 101 and the contact area between the guide roller 32 and the positive electrode sheet 101 will increase, the frictional force of the positive electrode sheet 101 will increase with respect to the guide roller 32 and the roller 61. Therefore, in the winding process, in comparison to the time at which the attachment process is ended, the resistance force against the winding deviation of the negative electrode sheet 101 with respect to the core 40 becomes larger, which allows the winding to be performed at a higher speed.

### Other Modifications of First Embodiment

It should be noted that the winding device may also include a configuration in which only the roller 61 moves when performing winding. Also, in this case, by moving the roller 61 away from the roller 62 in the circumferential direction around the center axis C, the distance between the rollers 61 and 62 becomes larger when performing winding. By increasing the area of the region S between the contact starting position P1B and the contact starting position P2B on the outer circumferential surface of the core 40, the resistance force against the winding deviation of the negative electrode sheet 102 with respect to the core 40 increases.

### Second Embodiment

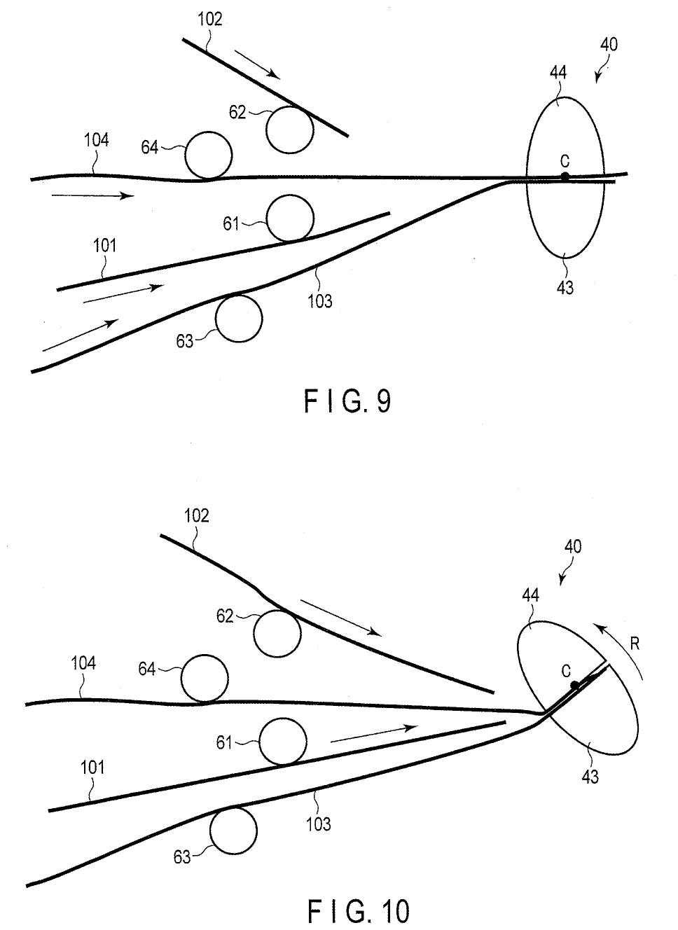

FIG. 9 shows a configuration of a winding device 1 according to a first embodiment. The winding device 1 of the present embodiment is a device for manufacturing an electrode group of a secondary battery using a positive electrode sheet 101, a negative electrode sheet 102, and two separator sheets 103 and 104 having electrical insulation. The winding device 1 is a device for manufacturing an electrode group by winding the positive electrode sheet 101 and the negative electrode sheet 102 around a core 40, where the positive electrode sheet 101 and the negative electrode sheet 102 overlap each other via the separators 103 and 104 interposed therebetween. Since the positive electrode sheet 101 and the negative electrode sheet 102 are the same as those in the first embodiment, descriptions thereof will be omitted.

The separator sheets 103 and 104 are inserted between the positive electrode sheet 101 and the negative electrode sheet 102 to prevent a short circuit from occurring by the positive electrode sheet 101 and the negative electrode sheet 102 coming into contact. Therefore, in the manufactured electrode group, a separator for electrically insulating the positive electrode from the negative electrode is formed by the separator sheets 103 and 104. The separator sheets 103 and 104 are configured by an insulator.

In the present embodiment, a supplying unit 10 includes two separator supplying mechanisms (not shown) for intermittently sending out the separator sheets 103 and 104, in addition to a supplying mechanism (supplier) for intermittently sending out the positive electrode sheet 101. Furthermore, a transfer unit 30 includes a guide roller (not shown) for guiding the separator sheets 103 and 104 supplied by the supplying unit 10 to the core 40.

A transfer path of the separator sheet 103 is positioned on the same side as a side at which the core 40 rotates in a circumferential direction around the center axis C of the core 40, with respect to a transfer path of the positive electrode sheet 101. A transfer path of the separator sheet 104 is positioned so that, in the circumferential direction around the center axis C of the core 40, it is positioned on a side opposite to a side at which the core 40 rotates, with respect to the transfer path of the positive electrode sheet 101, and on the same side as a side at which the core 40 rotates, with respect to a transfer path of the negative electrode sheet 102. Therefore, the transfer path of the separator sheet 104 is positioned between the transfer path of the positive electrode sheet 101 and the transfer path of the negative electrode sheet 102. Furthermore, the transfer path of the positive electrode sheet 101 is positioned between the transfer path of the separator sheet 103 and the transfer path of the separator sheet 104 in a circumferential direction around the center axis C of the core 40.

An adjustment mechanism 60 further includes a roller 63 and a roller 64. The roller 63 guides the separator sheet 103 supplied from the supplying unit 10 to the core 40. The roller 64 guides the separator sheet 104 supplied from the supplying unit 10 to the core 40. Each of the rollers 63 and 64 is attached to, for example, a frame (not shown). Each of the rollers 63 and 64 may have only one of its ends in an axial direction (longitudinal direction) or both ends in the axial direction fixed to a frame, etc.

To each of the rollers 61 to 63 a driving device 65 is connected. The driving device 65 is driven to move each of the rollers 61 to 63 between a reference position and a winding position. Each of the rollers 61 to 63 can be driven by the driving device 65 to move in the circumferential direction around the center axis C of the core 40. Depending on the position of the roller 63, an insertion angle of the separator sheet 103 changes with respect to the core 40. That is, the roller 63 defines the insertion angle of the separator sheet 103 with respect to the core 40.

Since reference positions and winding positions of the rollers 61 and 62 are the same as those in the first embodiment and the first modification, descriptions thereof will be omitted.

In a state where each of the rollers 61 to 63 is positioned at the reference position, the roller 63 is positioned on the same side as a side at which the core 40 rotates in the circumferential direction around the center axis C of the core 40, with respect to the transfer path of the separator sheet 103. The roller 64 is positioned so that, with respect to the transfer path of the separator sheet 104, it is on a side opposite to a side at which the core 40 rotates in the circumferential direction around the center axis C of the core 40, and, with respect to a transfer path of the negative electrode sheet 102, it is on the same side as a side at which the core 40 rotates. That is, the roller 64 is arranged between the separator sheet 104 and the negative electrode sheet 102 between the transfer unit 30 and the core 40.

In a state where each of the rollers 61 to 63 is positioned at the reference position, when attaching the end part the separator sheet 103 supplied from the supplying unit 20 to the core 40, the roller 63 is capable of guiding the separator sheet 103 to the core 40.

The winding position of the roller 63 is positioned on the same side as a side at which the core 40 rotates in a circumferential direction around the center axis C of the core 40, with respect to the reference position. Furthermore, the winding position of the roller 63 is positioned on a side away from the roller 61 in a circumferential direction around the center axis C of the core 40, with respect to the reference position.

By moving from the reference position to the winding position, the roller 63 moves to the same side as a side at which the core 40 rotates in the circumferential direction around the center axis C of the core 40. Furthermore, by moving from the winding position to the reference position, the roller 62 moves to an opposite side of a side at which the core 40 rotates in the circumferential direction around the center axis C of the core 40.

A control device 50 moves each of the rollers 61 to 63 from the reference position to the winding position based on the positive electrode sheet 101, the negative electrode sheet 102, and the separator sheets 103 and 104 being attached to the core 40. Furthermore, the control device 50 starts winding the positive electrode sheet 101, the negative electrode sheet 102, and the separator sheets 103 and 104 onto the core 40 based on the rollers 61 to 63 moving from the reference position to the winding position. Furthermore, the control device 50 moves each of the rollers 61 to 63 from the winding position to the reference position based on ending the winding of the positive electrode sheet 101, the negative electrode sheet 102, and the separator sheets 103 and 104 onto the core 40.

Operations of the winding device 1 of the present embodiment will now be described.

When manufacturing an electrode group which is a winding body of the positive electrode sheet 101, the negative electrode sheet 102, and the separator sheets 103 and 104 by using the winding device 1 of the present embodiment, the control device 50 first starts an attachment process.

In the attachment process, the control device 50 first inserts the separator sheets 103 and 104 between a grasping body 43 and a grasping body 44. The separator sheets 103 and 104 are attached to the core 40 by being grasped between the grasping body 43 and the grasping body 44. FIG. 9 shows a state in which the separator sheets 103 and 104 are grasped by the core 40.

Then, in a state where each of the rollers 61 to 63 is in the reference position, the control device 50 rotates the core 40 in a rotational direction at low speed, inserts the end part of the negative electrode sheet 102 between the separator sheet 104 and the outer circumferential surface of the core 40, and inserts the positive electrode sheet 101 between the separator sheet 103 and the separator sheet 104. FIG. 10 shows an aspect of inserting the end parts of the positive electrode sheet 101 and the negative electrode sheet 102. By inserting a certain amount of the end part of the negative electrode sheet 102 between the separator sheet 104 and the outer circumferential surface of the core 40, the negative electrode sheet 102 is attached to the core 40. By inserting a certain amount of the end part of the positive electrode sheet 101 between the separator sheet 103 and the separator sheet 104, the positive electrode sheet 101 is attached to the core 40. When the positive electrode sheet 101 and the negative electrode sheet 102 are attached to the core 40, the control device 50 ends the attachment process. At the time of ending the attachment process, the negative electrode sheet 102 is adhered to the outer circumferential surface of the core 40 from the outer side, the separator sheet 104 is adhered to the negative electrode sheet 102 from the outer side, the positive electrode sheet 101 is adhered to the separator sheet 104 from the outer side, and the separator sheet 103 is adhered to the positive electrode sheet 101 from the outer side.

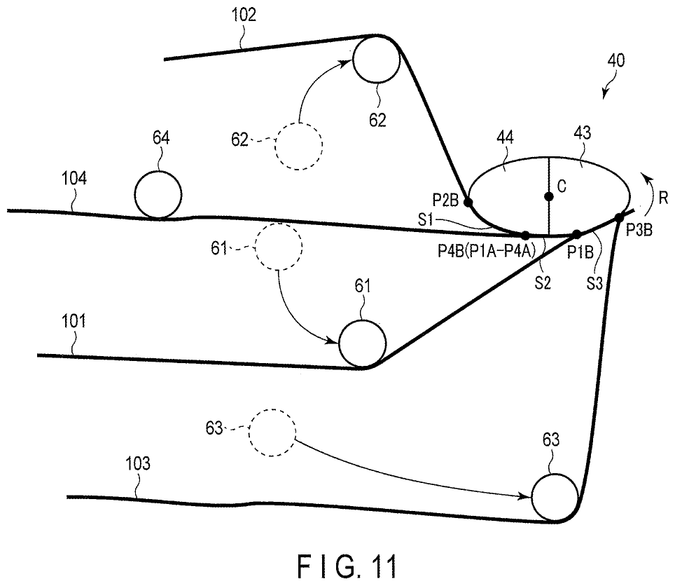

After ending the attachment process, the control device 50 starts a moving process. In the moving process, the control device 50 controls the driving device 65 to be driven to move each of the rollers 61 to 63 from the reference position to the winding position. FIG. 11 shows an aspect of moving the rollers 61 to 63 from the reference position to the winding position. After completion of moving the rollers 61 to 63, the control device 50 ends the moving process.

After ending the moving process, the control device 50 starts a winding process. In the winding process, in a state where each of the rollers 61 to 63 is positioned at the winding position, the control device 50 rotates the core 40 around the center axis C to wind the positive electrode sheet 101, the negative electrode sheet 102, and the separator sheets 103 and 104 onto the core 40.

Contact starting positions P1A and P1B are positions at which the positive electrode sheet 101 starts contacting the outer circumferential surface of the separator sheet 104 from the outer side. The contact starting positions P1A and P1B are points at which the positive electrode sheet 101 starts contacting the separator sheet 104, which is arranged on the inner side in the radial direction of the core 40, from the outer side. That is, the contact starting positions P1A and P1B are boundaries at which the contact state of the positive electrode sheet 101 with respect to the separator sheet 104 changes. Furthermore, contact starting positions P2A and P2B are positions at which the negative electrode sheet 102 starts contacting an inner side member from the outer side. The contact starting positions P2A and P2B are positions at which the negative electrode sheet 102 starts contacting the outer peripheral surface of the core 40 or the separator sheet 103. Here, the contact starting positions P2A and P2B will be described as positions at which the negative electrode sheet 102 starts contacting the outer peripheral surface of the core 40.

Furthermore, at the time of ending the attachment process, a position at which the separator sheet 103 starts contacting the outer circumferential surface of the positive electrode sheet 101 from the outer side is a contact starting position P3A, and, in the winding process, a position at which the separator sheet 103 starts contacting the outer circumferential surface of the positive electrode sheet 101 from the outer side is a contact starting position P3B. The contact starting positions P3A and P3B are points at which the separator sheet 103 starts contacting the positive electrode sheet 101, which is arranged on the inner side in the radial direction of the core 40, from the outer side. Similarly, at the time of ending the attachment process, a position at which the separator sheet 104 starts contacting the outer circumferential surface of the negative electrode sheet 102 from the outer side is a contact starting position P4A, and, in the winding process, a position at which the separator sheet 104 starts contacting the outer circumferential surface of the negative electrode sheet 102 from the outer side is a contact starting position P4B. Each of the contact starting positions P3A, P3B, P4A, and P4B forms a virtual straight line or an approximately straight line extending along the center axis C of the core 40 on the outer circumferential surface of the core 40.

At the time of ending the attachment process, the contact starting positions P1A to P4A are approximately the same positions in the circumferential direction around the center axis C of the core 40. Therefore, each of the area of a region S1 between the contact starting position P2A and the contact starting position P4A, the area of a region S2 between the contact starting position P4A and the contact starting position P1A, and the area of a region S3 between the contact starting position P1A and the contact starting position P3A becomes approximately zero. Since the area of the region S1 between the contact starting position P2A and the contact starting position P4A is approximately zero, at the contact starting position P4A of the separator sheet 104, a resistance force against a winding deviation of the negative electrode sheet 102, positioned on the inner side of the separator sheet 104, with respect to the core 40 becomes approximately zero. Furthermore, since the area of the region S2 between the contact starting position P4A and the contact starting position P1A is approximately zero, at the contact starting position P1A of the positive electrode sheet 101, a resistance force against a winding deviation of the separator sheet 104, positioned on the inner side of the positive electrode sheet 101, with respect to the core 40 becomes approximately zero. Furthermore, since the area of the region S3 between the contact starting position P1A and the contact starting position P3A is approximately zero, at the contact starting position P3A of the separator sheet 103, a resistance force against a winding deviation of the positive electrode sheet 101, positioned on the inner side of the separator sheet 103, with respect to the core 40 becomes approximately zero.

In the moving process, the roller 64 does not move. Therefore, the contact starting position P4B becomes approximately the same position as the contact starting positions P1A to P4A. Furthermore, in the region S1 between the contact starting position P2B and the contact starting position P4B, the negative electrode sheet 102 is positioned on the outermost side. Therefore, in the region S1, the outer circumferential surface of the negative electrode sheet 102 is exposed to the outer side. Furthermore, in the region S2 between the contact starting position P4B and the contact starting position P1B, the separator sheet 104 is positioned on the outermost side. Therefore, in the region S2, the outer circumferential surface of the separator sheet 104 is exposed to the outer side. Furthermore, in the region S3 between the contact starting position P1B and the contact starting position P3B, the positive electrode sheet 101 is positioned on the outermost side. Therefore, in the region S3, the outer circumferential surface of the positive electrode sheet 101 is exposed to the outer side.

Furthermore, in the winding process, in comparison to the time at which the attachment process is ended, the area of the region S2 between the contact starting position P1B of the positive electrode sheet 101 and the contact starting position P4B of the separator sheet 104 on the outer circumferential surface of the core 40 becomes larger. Therefore, in the winding process, in comparison to the time at which the attachment process is ended, a frictional force acting between the outer circumferential surface of the negative electrode sheet 102 and the separator sheet 104 becomes larger at the contact starting position P1B of the positive electrode sheet 101. Furthermore, by increasing the frictional force, in the winding process, in comparison to the time at which the attachment process is ended, the resistance force against the winding deviation of the separator sheet 104 with respect to the core 40 and the negative electrode sheet 102 becomes larger. Therefore, for example, even in a case where a counterforce of the bending moment occurring on the positive electrode sheet 101 acts on the separator sheet 104 from the positive electrode sheet 101, the winding deviation of the separator sheet 104 with respect to the core 40 and the negative electrode sheet 102 can be prevented from occurring.

Furthermore, in the winding process, in comparison to the time at which the attachment process is ended, the area of the region S1 between the contact starting position P2B of the negative electrode sheet 102 and the contact starting position P4B of the separator sheet 104 on the outer circumferential surface of the core 40 becomes larger. Therefore, in the winding process, in comparison to the time at which the attachment process is ended, a frictional force acting between the outer circumferential surface of the core 40 and the negative electrode sheet 102 at the contact starting position P4B of the separator sheet 104 becomes larger, and a resistance force against the winding deviation of the negative electrode sheet 102 with respect to the core 40 becomes larger. In this manner, the winding deviation of the negative electrode sheet 102 with respect to the core 40 is prevented from occurring.

Furthermore, in the winding process, in comparison to the time at which the attachment process is ended, an area of the region S3 between the contact starting position P3B of the separator sheet 103 and the contact starting position P1B of the positive electrode sheet 101 on the outer circumferential surface of the core 40 becomes larger. Therefore, in the winding process, in comparison to the time at which the attachment process is ended, a frictional force acting between the outer circumferential surface of the separator sheet 104 and the positive electrode sheet 101 at the contact starting position P3B of the separator sheet 103 becomes larger, and a resistance force against the winding deviation of the positive electrode sheet 101 with respect to the core 40, the negative electrode sheet 102, and the separator sheet 104 becomes larger.

An effect of the winding device 1 of the present embodiment will now be described.

The adjustment mechanism 60 of the winding device 1 of the present embodiment varies the size of an area of a region between a first position and a second position on the outer circumferential surface of the core 40. Furthermore, the area of the region (S1 to S3) when winding a plurality of band bodies (101 to 104) is larger than the area of the region (S1 to S3) when attaching the plurality of band bodies (101 to 104).

For example, in a case where the negative electrode sheet 102 corresponds to a first band body, the separator sheet 104 corresponds to a second band body. In this case, the roller 62 corresponds to a first roller, and the roller 64 corresponds to a second roller. Furthermore, the contact starting position (P2A, P2B) corresponds to the first position, and the contact starting position (P4A, P4B) corresponds to the second position. The region S1 corresponds to a region between the first position and the second position. Furthermore, in a case where the separator sheet 104 corresponds to the first band body, the positive electrode sheet 101 corresponds to the second band body. In this case, the roller 64 corresponds to the first roller, and the roller 61 corresponds to the second roller. Furthermore, the contact starting position (P4A, P4B) corresponds to the first position, and the contact starting position (P1A, P1B) corresponds to the second position. The region S2 corresponds to a region between the first position and the second position. Furthermore, in the case where the positive electrode sheet 101 corresponds to the first band body, the separator sheet 103 corresponds to the second band body. In this case, the roller 61 corresponds to the first roller, and the roller 63 corresponds to the second roller. Furthermore, the contact starting position (P1A, P1B) corresponds to the first position, and the contact starting position (P3A, P3B) corresponds to the second position. The region S3 corresponds to a region between the first position and the second position.

According to the winding device 1 of the present embodiment, the above configuration increases each of the areas of the region (S1 to S3) when winding a plurality of band bodies (101 to 104) from the time of attaching the plurality of band bodies (101 to 104) onto the core 40, thereby increasing the frictional force acting on the band bodies 101, 102, and 104 positioned on the inner side with respect to one of the band bodies 101 to 104 upon winding. When the frictional force acting on the band bodies 101, 102, and 104 increases, the resistance force against the winding deviation of the band bodies 101, 102, and 104 increases. In this manner, the winding deviation of the band bodies 101, 102, and 104 is effectively prevented from occurring at the contact starting position.

It should be noted that, in the present embodiment, although each of the rollers 61 to 63 among the rollers 61 to 64 is movable, it is not limited thereto. For example, only the roller 61 among the rollers 61 to 64 may be movable. In this case, the adjustment mechanism 60 varies the size of an area of the region S2 between the contact starting position (P4A, P4B) and the contact starting position (P1A, P1B) on the outer circumferential surface of the core 40. Furthermore, the area of the region S2 upon winding becomes larger than the area of the region S2 upon attachment. This allows the frictional force acting on the outer circumferential surface of the negative electrode sheet 102 and the separator sheet 104 upon winding to increase, thereby increasing the resistance force against the winding deviation of the separator sheet 104 with respect to the core 40 and the negative electrode sheet 102. Here, the separator sheet 104 is made thinner than the positive electrode sheet 101 and the negative electrode sheet 102. Therefore, the separator sheet 104 is more deformable compared to the positive electrode sheet 101 and the negative electrode sheet 102, and is susceptible to winding deviation upon winding. Accordingly, by increasing only the resistance force against the winding deviation of the separator sheet 104, which is susceptible to winding deviation, the winding deviation of the band body can be efficiently suppressed, and the device can be attempted to be minimized.

### Modifications of First Embodiment and Second Embodiment

In the above-described embodiments and modifications thereof, as an example, a winding device 1 for manufacturing an electrode group of a secondary battery is described. However, it is not limited thereto. The winding device may be any device as long as it manufactures a winding body obtained by winding a plurality of band bodies in an overlapped state. For example, the configurations according to the above-described embodiments and modifications thereof may also be applied to a winding device that manufactures winding bodies other than electrode groups of a secondary battery. Furthermore, the number of band bodies used for manufacturing a winding body may be three pieces, five pieces, or more.

Furthermore, the positive electrode sheet 101 and the negative electrode sheet 102 may be reversed. For example, instead of the positive electrode sheet 101, a negative electrode sheet may be used, and, instead of the negative electrode sheet 102, a positive electrode sheet may be used.

According to at least one of the embodiments or examples, the winding device includes an adjuster that varies the size of an area of a region between a first position and a second position, where the first position is a position at which a first band body starts contacting a member on an inner side of the first band body from the outer side, and the second position is a position at which a second band body starts contacting the first band body from the outer side. In this manner, a winding device that can suppress a winding deviation of a band body, and a manufacturing method of a winding body can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A winding device configured to manufacture a winding body obtained by winding a plurality of band bodies including a first band body and a second band body in an overlapped state, the second band body being adhered to the first band body from an outer side, the device comprising:
a core having a center axis and winding the plurality of band bodies by rotating around the center axis; and
an adjuster configured to vary the size of an area of a region between a first position and a second position on an outer circumferential surface of the core, the first position being a position at which the first band body starts contacting a member on an inner side of the first band body from an outer side, the second position being a position at which the second band body starts contacting the first band body from an outer side.

2. The winding device according to claim 1, wherein the area of the region when winding the plurality of band bodies onto the core is larger than the area of the region when attaching the plurality of band bodies onto the core.

3. The winding device according to claim 1, wherein, in the region, the first band body among the plurality of band bodies is positioned on an outermost side.

4. The winding device according to claim 1, wherein, when attaching the plurality of band bodies onto the core, the first position and the second position are positioned at a same position in a circumferential direction around the center axis.

5. The winding device according to claim 1, wherein the adjuster comprises:
a first roller that guides the first band body to the core;
a second roller that guides the second band body to the core; and
a driver that is connected to at least one of the first roller and the second roller, and, by moving at least one of the first roller and the second roller, varies one of the first position and the second position corresponding thereto.

6. A manufacturing method of manufacturing a winding body obtained by winding a plurality of band bodies including a first band body and a second band body in an overlapped state, the second band body being adhered to the first band body from an outer side, the method comprising:
attaching the plurality of band bodies onto a core having a center axis;
based on ending attachment of the plurality of band bodies onto the core, increasing an area of a region between a first position and a second position on an outer circumferential surface of the core, the first position being a position at which the first band body starts contacting a member on an inner side of the first band body from an outer side, the second position being a position at which the second band body starts contacting the first band body from an outer side; and
after increasing the area of the region between the first position and the second position, winding the plurality of band bodies onto the core by rotating the core around the center axis.
